(19) United States
(12) Patent Application Publication
(10) Pub. No.: US 2020/0063531 A1
(43) Pub. Date: Feb. 27, 2020

(54) SYSTEMS AND METHODS FOR A CLOSED LOOP POWER SYSTEM

(71) Applicant: John Tuma, Centerville, TX (US)

(72) Inventor: John Tuma, Centerville, TX (US)

(21) Appl. No.: 16/528,802

(22) Filed: Aug. 1, 2019

Related U.S. Application Data
(60) Provisional application No. 62/720,488, filed on Aug. 21, 2018.

(51) Int. Cl. E21B 41/00; E21B 43/34; B01D 53/00

(52) U.S. Cl. CPC E21B 41/0085; B01D 53/002; E21B 43/34

(57) ABSTRACT

Embodiments described herein disclose a closed loop power system for a wellbore that utilizes produced gas to create electrical energy, wherein the electrical energy is utilized by local production systems. Embodiments may include a wellbore, drilling equipment, gas conditioner, and turbine electricity.

### BACKGROUND INFORMATION

### Field of the Disclosure

Examples of the present disclosure are related to systems and methods for a closed loop power system. Specifically, embodiments describe utilizing gas collected from a wellbore to power a turbine, which in turn produces electric energy, and the electrical energy is utilized in a process to obtain the subsequent gas from the wellbore to power the turbine

### Background

Hydraulic injection is a method performed by pumping fluid into a formation at a pressure sufficient to create fractures in the formation. When a fracture is open, a propping agent may be added to the fluid. The propping agent, e.g. sand or ceramic beads, remains in the fractures to keep the fractures open when the pumping rate and pressure decreases or ceases. During a production stage, oil and gas may flow from the fractures towards the upper sections of the wellbore.

Currently, there is an excessive amount of gas produced in oil fields that have little or no value. This produced gas is typically wet or has a high BTU, and cannot be used in an internal combustion engine. To meet current environmental regulations, it is typically necessary to flare or burn off the produced gas to obtain the produced oil However, regulatory rules only allow for short term flaring. This leads to wells being shut off and significant downtime to process the produced gas.

Accordingly, needs exist for closed loop power systems and methods that utilize the produced case to produce electricity, wherein the produced electricity is locally used within production systems, which in turn produce the gas.

### SUMMARY

Embodiments described herein disclose a closed loop power system for a wellbore that utilizes produced gas to create electrical energy, wherein the electrical energy is utilized by local production systems. Embodiments may include a wellbore, drilling equipment, gas conditioner, and turbine electricity.

The wellbore may be positioned within a geological formation, and may include natural recourses. The natural resources may include oil and gas.

The drilling equipment may include machines that are configured to create holes within and extract the natural resources. The drilling equipment may include machines that are mechanically powered, electrically powered, hydraulically powered, and a combination.

A gas conditioner may be configured to receive gas extracted from the wellbore by the drilling equipment, and condition the gas. The conditioned gas may be burned in the turbine engine, wherein the turbine is utilized to power the drilling equipment. The gas conditioner may be configured to pressurize the received gas to create a pressure differential to remove natural gas liquids, pass the gas through a duel stage coilessor to collect remaining liquids, which may condition the gas to burn in the turbine engine.

The turbine engine may be configured to be powered by the conditioned gas to produce electricity. The electricity produced by the turbine engine may be used to displace diesel fuel usage on the drilling equipment. To this end, embodiments may be utilized to reduce cost savings for an operator by conditioning gas, reduce emissions, eliminate gas flaring, and allows the drilling equipment to be continually online. Furthermore, the electricity produced, which is more cost effective to use than line power from the power companies, is also used to power oil production facilities where line power may not be available.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a closed loop power system, according to an embodiment.

FIG. 2 depicts a method for a closed loop power system, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

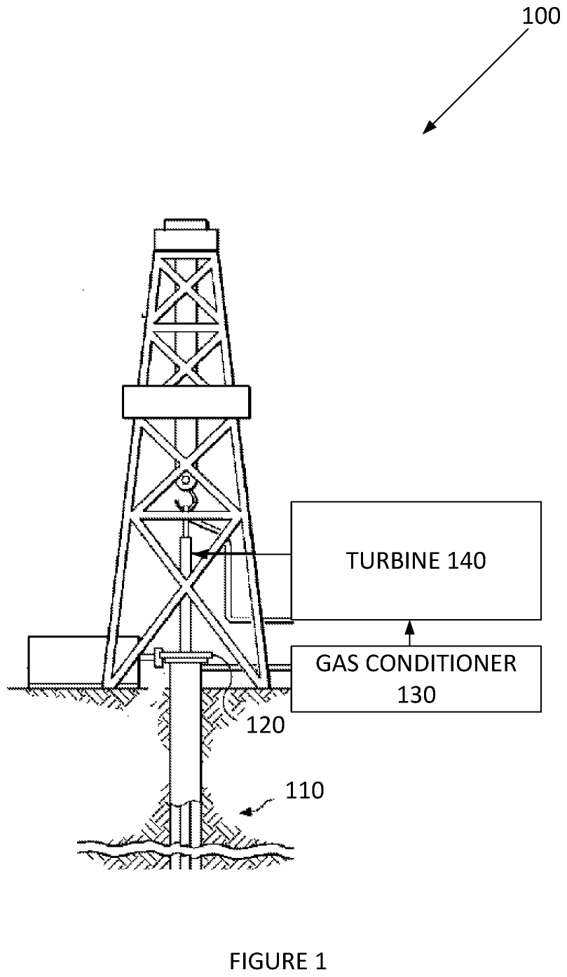

FIG. 1 depicts a closed loop power system 100, according to an embodiment. Closed loop power system 100 may be configured to receive, condition, and use locally cultivated gases at a wellbore. This may limit, reduce, etc. the amount of outside power that is necessary to power drilling machinery, while also reducing harmful emissions generated at the wellbore. System 100 may include a wellbore 110, drilling equipment 120, gas conditioner 130, and turbine engine 140.

Wellbore 110 may be positioned within a geological formation, and may include natural recourses. The natural resources may include oil and gas. Wellbore 110 may be a hole that is drilled to aid in the exploration and recovery of the natural resources. The wellbore may be encased by materials, such as steel and cement, or it may be uncased.

Drilling equipment 120 may include machines that are configured to create wellbore 110, and extract the natural resources. Drilling equipment 120 may include machines that are mechanically powered, electrically powered, hydraulically powered, and a combination. In embodiments, the extracted natural resources may include oil and gas. The extracted gas may be associated gas that is produced with the oil, and the extracted gas may be wet or have a high BTU, which cannot be used in an internal combustion engine. For example, the extracted gas may include natural gas liquids, which increases the BTU of the gas.

Gas conditioner 130 may be configured to receive gas extracted from wellbore 110 via drilling equipment 120. Gas conditioner 130 may also be configured to condition the gas to burn in turbine engine 140. For example, the gas conditioner 130 may include a gas compressor that is configured to decrease or increase the pressure of the gas by reducing its volume. By changing the pressure of the gas, saturated natural gas liquids may be removed from the gas. Gas conditioner 130 may also include a heater that is configured to increase the heat of the gas to keep the dew point of the gas in a vapor state, and not liquid during pressurization or depressurization. Gas conditioner 130 may also include a coalescer that is configured to separate liquids from the extracted gas.

Turbine engine 140 may be a rotary mechanical device that is configured to be run on the conditioned gas, and generate electricity. The electricity produced, may be utilized to operate drilling equipment 120. In embodiments, a combustion engine may not be able to operate using the conditioned gas, but turbine engine 140 may be able to operate utilizing the conditioned gas.

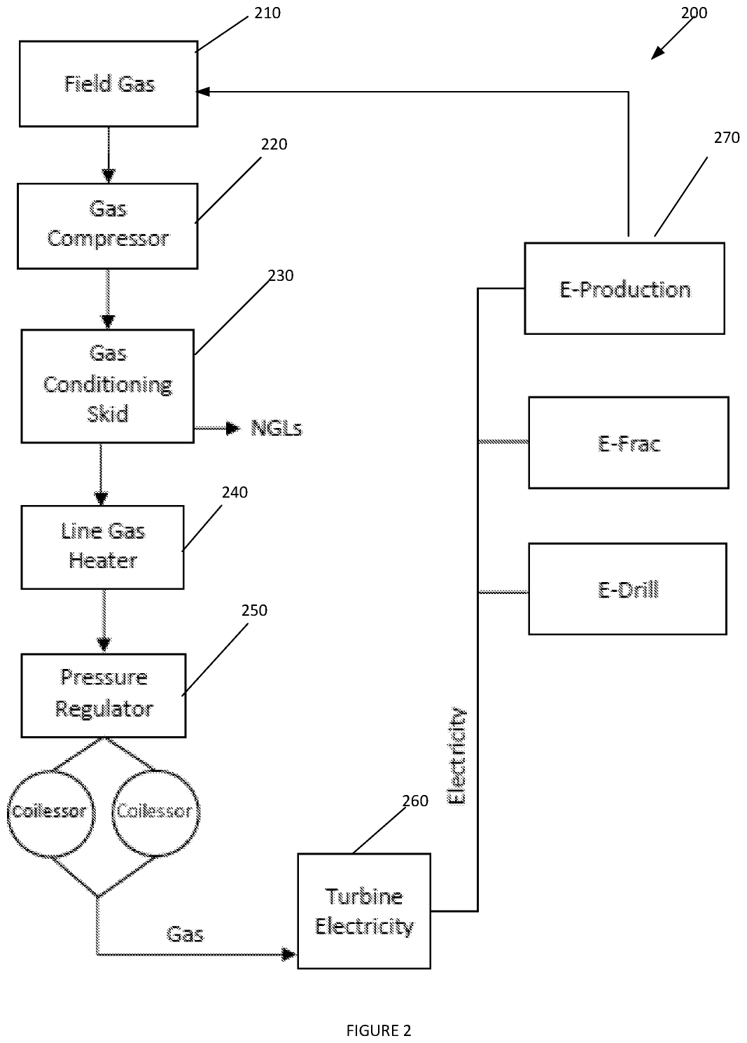

FIG. 2 depicts a method 200 for a closed loop power system. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

At operation 210, associated gas may be extracted from a wellbore along with oil. The associated gas may have a higher saturation of liquids or has a high BTU, which does not allow the associated gas to be used by combustion engines.

At operation 220, the associated gas is compressed to a higher pressure. The higher pressure may remove natural gas liquids, which lowers the BTU value of the gas and dries the gas.

At operation 230, the compressed gas may be processed by a gas conditioning skid. The gas conditioning skid may be configured for hydrocarbon dew point control that increases the recovery of natural gas liquids. The gas conditioning skid may remove liquid droplets and solid contaminants from the gas.

At operation 240, a temperature of the conditioned gas may be changed. The temperature of the gas may be changed to keep a dew point of the gas in a vapor state during pressurization or depressurization.

At operation 250, the temperature controlled conditioned gas may be pressurized or depressurized to remove further liquids from the gas. The remaining liquids within the gas may be collected by a coalescer.

At operation 260, the conditioned gas may be utilized by a turbine to make electricity, wherein the turbine is located at the same geographic location as the wellbore producing the gas.

At operation 270, the electricity generated by the turbine located at the wellbore may be utilized by drilling machinery, wherein the drilling machinery may be utilized to extract the associated gas.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

1. A closed loop power system at a wellbore, the system comprising:
a gas conditioner configured to receive extracted gas from the wellbore and condition the extracted gas;
a turbine engine configured to be powered by the conditioned gas, the turbine engine being configured to produce electricity based on the conditioned gas;
drilling equipment configured to be powered by the electricity produced by the turbine engine to create holes within the wellbore to allow the gas to be extracted.

2. The system of claim 1, wherein the gas conditioner, turbine engine, and drilling equipment are all positioned at a wellsite that includes the wellbore.

3. The system of claim 2, wherein the extracted gas is associated gas that is produced with oil and includes a high BTU.

4. The system of claim 3, wherein the gas conditioner includes a gas compressor configured to remove liquids from the extracted gas.

5. The system of claim 4, wherein the gas conditioner includes a heater that is configured to increase a temperature of the extracted gas to maintain a dew point of the extracted gas in a vapor state.

6. The system of claim 5, wherein the gas conditioner includes a coalescer configured to separate the removed liquids from the extracted gas.

7. The system of claim 6, wherein the gas conditioner is configured to be powered by the electricity produced by the turbine engine.

8. The system of claim 2, wherein the turbine engine is configured to only supply the electricity to local production systems at the wellsite.

9. The system of claim 1, wherein the gas conditioner and the turbine engine are operating while the drilling equipment is extracting natural resources from the wellbore.

10. The system of claim 1, wherein the closed loop power system at the wellbore operates while line power is not available locally.

11. A method for forming closed loop power system at a wellbore, the method system comprising:
drilling the wellbore with drilling equipment to extract gas;
receiving, at a gas conditioner, the extracted gas from the wellbore;
conditioning the extracted gas;
powering a turbine engine via the extracted gas;
producing electricity, via the turbine engine, based on the conditioned gas, wherein the drilling equipment is powered by the electricity produced by the turbine engine to create holes within the wellbore to allow the gas to be extracted.

12. The method of claim 11, further comprising:
positioning the gas conditioner, turbine engine, and drilling equipment at a wellsite that includes the wellbore.

13. The method of claim 12, wherein the extracted gas is associated gas that is produced with oil and includes a high BTU.

14. The method of claim 13, further comprising:
compressing the extracted gas to remove liquids from the extracted gas.

15. The method of claim 14, further comprising;:
heating the extracted gas to maintain a dew point of the extracted gas in a vapor state.

16. The method of claim 15, further comprising:
separating the removed liquids from the extracted gas.

17. The method of claim 16, further comprising:
powering the gas conditioner by the electricity produced by the turbine engine.

18. The method of claim 12, further comprising:
suppling the electricity from the turbine engine only to local production systems at the wellsite.

19. The method of claim 11, wherein the gas conditioner and the turbine engine are operating while the drilling equipment is extracting natural resources from the wellbore.

20. The method of claim 11, wherein the closed loop power system at the wellbore operates while line power is not available locally.
